(19) United States
(12) Patent Application Publication
(10) Pub. No.: US 2016/0207602 A1
(43) Pub. Date: Jul. 21, 2016

(54) Nosecone Transducer Array

(71) Applicant: Navico Holding AS, Egersund (NO)

(72) Inventor: Jeremiah Clark, Tulsa, OK (US)

(21) Appl. No.: 14/598,122

(22) Filed: Jan. 15, 2015

(51) Int. Cl. B63H 20/00; G01S 15/89; G10K 11/18

(52) U.S. Cl. CPC B63H 20/007; G10K 11/18; G01S 15/89

(57) ABSTRACT

Various implementations described herein are directed to a trolling device having a motor with a propeller coupled to the motor and a shaft configured to couple or mount the motor to a watercraft. The trolling device may include a housing encapsulating the motor, and the housing may include a nosecone having a transducer array incorporated within the nosecone.

### BACKGROUND

This section is intended to provide information to facilitate an understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

When trolling for fish, a secondary motor may be used as means of propulsion for trolling purposes. Typically, a trolling motor is a self-contained device coupled to an angler's watercraft and is useful for precise positioning in a body of water.

### SUMMARY

Described herein are implementations of various technologies for a nosecone transducer array. In one implementation, a device may include a motor, a propeller coupled to the motor, and a shaft configured to couple the motor to a watercraft. The device may include a housing encapsulating the motor, and the housing may include a nosecone having a transducer array incorporated within the nosecone.

Described herein are also implementations of various technologies for a trolling motor. In one implementation, a trolling motor may include an electric motor having a propeller coupled thereto and a steering shaft configured for coupling the electric motor to a watercraft. The trolling motor may include a housing encapsulating the electric motor, and the housing may include a nosecone having a transducer array incorporated within the nosecone.

Described herein are also implementations of various technologies for a system having a nosecone transducer array. In one implementation, the system may include a trolling device configured to be coupled to a watercraft. The trolling device may include a motor having a propeller coupled thereto. The trolling device may include a housing enclosing the motor within a waterproof capsule. The housing may include a nosecone with a transducer array incorporated therein. The trolling device may include a steering shaft configured for coupling the housing to the watercraft. The steering shaft may include a first electrical wire for transmitting sonar signals from the transducer array. The system may include a computing device electrically coupled to the trolling device via the first electrical wire. The computing device may include a processor and memory having instructions that cause the processor to record sonar data associated with the sonar signals received from the transducer array via the first electrical wire.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Moreover, the claimed subject matter is not limited to implementations that solve any or all disadvantages noted in any part of this disclosure.

### BRIEF DESCRIPTION OF THE DRAWINGS

Implementations of various techniques are described herein with reference to the accompanying drawings. It should be understood, however, that the accompanying drawings illustrate only the various implementations described herein and are not meant to limit the scope of various techniques described herein.

FIG. 1 illustrates a view of using a trolling motor in accordance with various implementations described herein.

FIG. 2 illustrates a diagram of a trolling motor in accordance with various implementations described herein.

FIG. 3 illustrates a diagram of a transducer system in accordance with various implementations described herein.

FIG. 4 illustrates a schematic of a marine electronics device in accordance with various implementations described herein.

### DETAILED DESCRIPTION

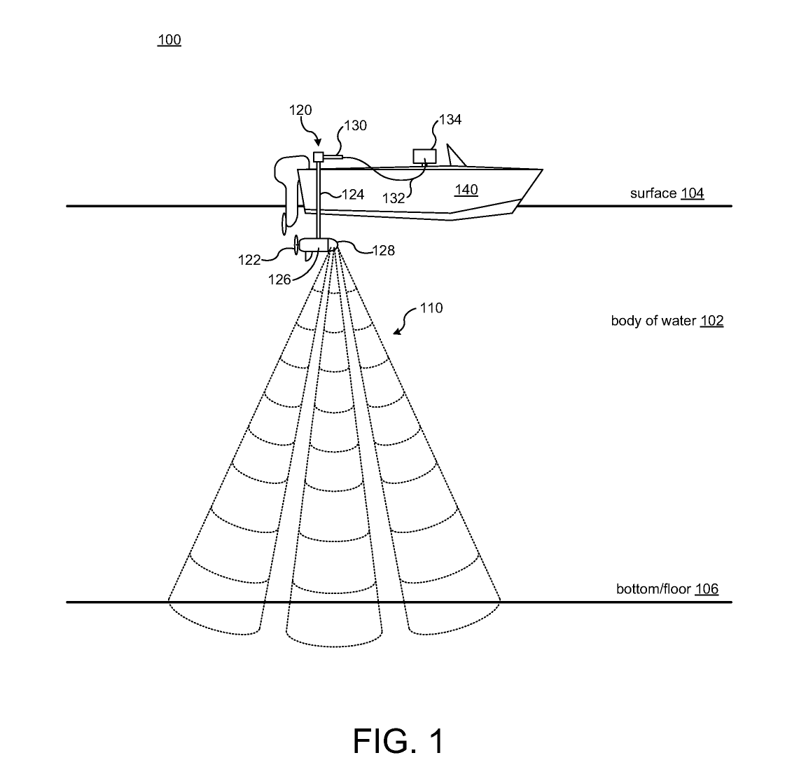

Various implementations of incorporating a sonar transducer array within a nosecone of a trolling motor will now be described in reference to FIGS. 1-4.

FIG. 1 illustrates a view of using a trolling motor 120 in accordance with various implementations described herein.

In some implementations, the trolling motor 120 includes a device having a motor (not shown) with a propeller 122 coupled thereto and a shaft 124 coupling the motor to a watercraft 140 (e.g., boat). As shown in FIG. 1, the trolling motor 120 may be coupled or mounted to a stern of the watercraft 140. In some instances, the trolling motor 120 may be coupled or mounted to another part of the watercraft 140, such as, e.g., a bow of the watercraft 140 or some other useful part of the watercraft 140. During operation, the motor is configured to drive the propeller 122 to provide thrust for the watercraft 140 in water, such as a body of water 102. The shaft 124 may be configured to rotate relative to the watercraft 140 to allow steering of the watercraft 140 via user interaction with a handle 130 in the body of water 102 during operation of the motor. In some examples, the trolling motor 120 may include use of a manually operated steering mechanism; however, in other examples, the trolling motor may use a motorized mechanism for steering, which may include use of a cable steer type trolling motor or an electric steer type trolling motor. The trolling motor 120 includes a housing 126 that encapsulates the motor, and the housing 126 includes a nosecone 128 having a transducer array (not shown) incorporated therein. The housing 126 may be configured to enclose the motor within a waterproof capsule that is impervious to water. The housing 126 and the nosecone 128 may be formed with a hydrodynamic profile or hydrodynamic contour, such as a torpedo shape.

As shown in FIG. 1, the trolling motor 120 is a stand-alone device that may be coupled to the watercraft 140 and deployed in the body of water 102. The watercraft 140 may be configured to float on a surface 104 of the body of water 102. During operation, the transducer array incorporated within the nosecone 128 of the housing 126 may be configured for imaging various environmental features (e.g., fish, plants, rocks, etc.) in the body of water 102. This imaging may include mapping an underwater environment below the surface 104 of the body of water 102 between the surface 104 and a bottom or floor 106 of the body of water 102. The shaft 124 may be configured to rotate the housing 126 relative to the watercraft 140 via user interaction with the handle 130 to rotate the nosecone 128 (including the incorporated transducer array) at least 360° for imaging a 360° view of the underwater environment below the surface 104 of the body of water 102.

As shown in FIG. 1, one or more sonar beams 110 may be generated by multiple sonar transducer elements of the transducer array that is incorporated within the nosecone 128 of the housing 126 of the trolling motor 120 when deployed in the body of water 102. The transducer array may be referred to as a forward scanning sonar transducer array including spotlight scan transducers that are built-in to the nosecone 128. The spotlight scan transducers may be referred to as forward scanning sonar transducers. In some instances, the transducer array may include one or more of a right forward scanning element, a left forward scanning element, a conical sonar element, and a bar downscan sonar element, which may be housed inside the nosecone 128 of the housing 126.

In some implementations, the multiple sonar scanning elements are each capable of generating a separate sonar beam 110. The sonar beams 110 may include one or more of a conical beam projection and a linear beam projection. For instance, the sonar beams 110 may include a conical downscan beam projection having a coverage area of a beam produced by a circular downscan transducer. In another instance, the sonar beams 110 may include a linear downscan beam projection having a coverage area of a beam produced by a linear downscan transducer.

In some implementations, the trolling motor 120 may be electrically coupled to a computing device 134 via one or more electrical wires or cables 132 passing through the shaft 124. The computing device 134 may be a marine electronics device (e.g., multi-function display (MFD), smart phone, etc.) for recording sonar data signals received from the transducer array via the electrical cables 132. The computing device 134 may also be configured for controlling operation of the motor via the electrical cables 132. Thus, control signals may be transmitted from the computing device 134 to the motor via the electrical cables 132 for controlling operation of the motor. In some instances, operation of the motor is controlled by the computing device 134 including user interaction with the computing device 134. In some other instances, operation of the motor may be controlled via user interaction with a foot-pedal (not shown) positioned on the watercraft 140.

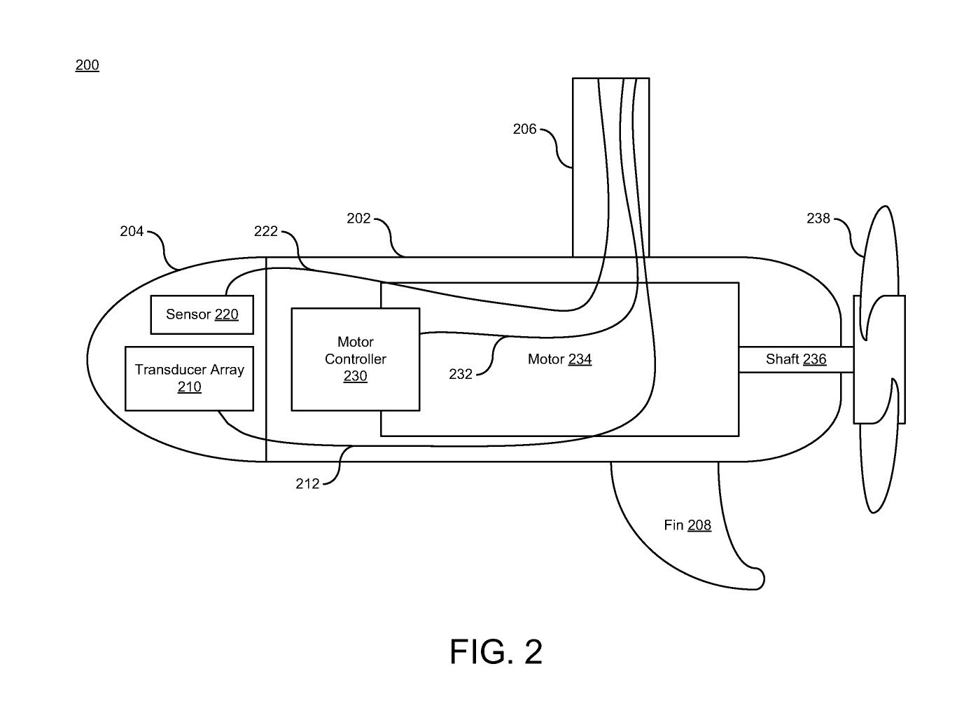

FIG. 2 illustrates a block diagram of a trolling motor 200 in accordance with various implementations described herein. In various implementations, the trolling motor 200 may include and/or incorporate use of various types of electrically and/or mechanically steered trolling motors. In some instances, some trolling motors may be electrically steered via a remote device, foot pedal, or multi-functional display (MFD). In other instances, some trolling motors may be mechanically steered via a handheld tiller type control or a mechanical cable steered foot pedal.

The trolling motor 200 includes a device having a housing 202 configured to encapsulate a motor 234. The housing 202 includes a nosecone 204 and a transducer array 210 incorporated within the nosecone 204. The trolling motor 200 includes a propeller 238 coupled to the motor 234 via a drive shaft 236. The trolling motor 200 includes a steering shaft 206 that couples the motor 234 (and housing 202) to a watercraft (e.g., a boat). The motor 234 may include an electric motor, and the motor 234 may be configured to drive the propeller 238 in water to provide thrust for the watercraft in a body of water 102 during operation of the electric motor. The trolling motor 200 may include a fin 208 for stability in water during movement.

The steering shaft 206 may incorporate use of a first electrical cable 232 for controlling operation of the motor 234 via a motor controller 230. Operation of the motor 234 may be controlled by a variable power supply, such as a foot-pedal, that provides variable control signals to the motor controller 230, and the motor controller 230 relays the variable control signals to the motor 234 to drive the motor 234. In another instance, operation of the motor 234 may be controlled by an external computing device, such as the computing device 134 in FIG. 1. In this instance, the external computing device may provide variable control signals to the motor controller 230, and the motor controller 230 relays the variable control signals to the motor 234 to drive the motor 234.

The steering shaft 206 may incorporate use of a second electrical cable 212 for transmitting sonar data signals from the transducer array 210 to a computing device, such as the computing device 134 in FIG. 1. The transducer array 210 may include a spotlight transducer array having multiple scanning transducers. The transducer array may include multiple transducer elements including one or more of a right scanning transducer, left scanning transducer, a down scanning transducer, and a conical down beam transducer. The sonar data generated and transmitted by the transducer array 210 may be used for imaging environmental features in the body of water 102.

Generally, the term sonar (i.e., SOund Navigation And Ranging) refers to various techniques for propagating sound underwater to detect objects on or under a surface of a body of water, such as fish, plants, rocks, sea floor, etc. One type of sonar technology refers to active sonar that is configured to emit pulses of sound waves while receiving echoes, which refers to pinging. Sonar may be used to determine acoustic locations and/or measurements of echo characteristics for targets and objects in a body of water. Further, acoustic frequencies used in sonar based devices may vary from low frequency (i.e., infrasonic) to high frequency (i.e., ultrasonic).

The transducer array 210 may include multiple sonar transducer elements that may be configured to use sonar technology to evaluate attributes of a target object by interpreting echoes from sound waves. In various implementations, each sonar transducer element may be configured to actively generate low and/or high frequency sound waves and evaluate echoes received back to thereby measure time intervals between sending signals and receiving corresponding echoes to determine distance to target objects. Each sonar transducer element may be configured to convert energy into sound waves using piezoelectric transducers or capacitive transducers that are configured to convert electrical energy into sound. Each sonar transducer element may be configured to use piezoelectric crystals that include a property of changing size when voltage is applied, whereby applying an alternating current (AC) across the piezoelectric crystals may cause oscillations at high frequencies, to thereby generate high frequency sound waves. In some instances, focusing sound waves generated by each sonar transducer element may be determined by an area and shape of each sonar transducer element, a sound wave frequency of each sonar transducer element, and a sound velocity of the propagation medium, such as a body of water. In some instances, each sonar transducer element may use piezoelectric crystals configured as transceivers to transmit and detect sound waves in one or more elements, such as propagating sound waves and receiving echoing sound waves.

The trolling motor 200 may include one or more sensors 220 incorporated within the nosecone 204. Further, the steering shaft 206 may incorporate use of a third electrical cable 222 for transmitting sensor data signals from the one or more sensors 220 to a computing device, such as the computing device 134 in FIG. 1. The one or more sensors 220 may include a dedicated sensor (e.g., water sensor) configured for sensing deployment/removal of the trolling motor 200 in/from the body of water 102. For instance, the dedicated sensor may include electrode terminals (not shown) configured to activate (e.g., power-up) the transducer array 210 when the trolling motor 200 is deployed in water. The electrode terminals may be configured to deactivate (e.g., power-down) the transducer array 210 when the trolling motor 200 is removed from water. The one or more sensors 220 may include one or more environmental sensors, such as a temperature sensor.

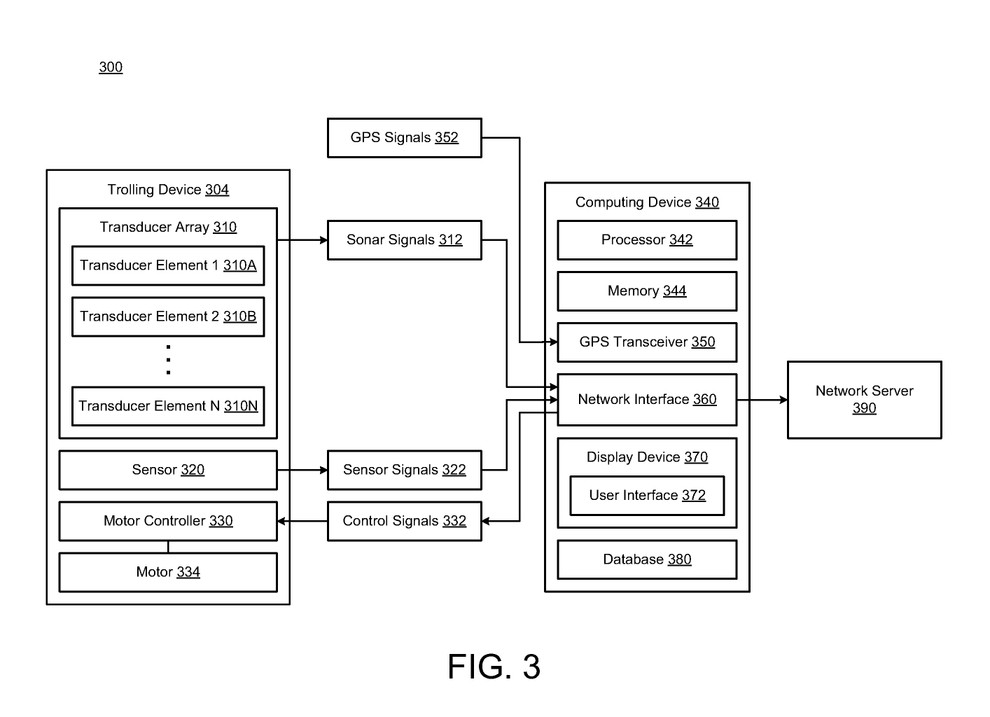

FIG. 3 illustrates a block diagram of a transducer system 300 in accordance with implementations of various techniques described herein.

The transducer system 300 includes a trolling device 304, a computing device 340, and a network server 390. The trolling device 304 and the computing device 340 are coupled to a watercraft, e.g., boat. The trolling device 304 may be a trolling motor, and the computing device 340 may be a marine electronics device, a multi-function display (MFD), a smart phone, etc.

The trolling device 304 includes a transducer array 310. The transducer array 310 may include a spotlight transducer array having multiple scanning transducers 310A, 310B, . . . , 310N, which may include one or more of a right scanning transducer, a left scanning transducer, a down scanning transducer (e.g., bar downscan transducer), and a conical down beam transducer. The trolling device 304 includes one or more sensors 320. The one or more sensors 320 may include one or more environmental sensors, such as a water sensor and temperature sensor. The trolling device 304 includes a motor 334 controlled with a motor controller 330.

The computing device 340 includes a processor 342 and memory 344 including instructions that cause the processor 342 to process and record sonar data associated with sonar signals 312 received from the transducer array 310 via a network interface 360. The instructions may further cause the processor 342 to process and record sensor data associated with sensor signals 322 received from the one or more sensors 320 via the network interface 360. The instructions may further cause the processor 342 to generate control signals 332 for controlling operation of the motor 334 via the motor controller 330 and the network interface 360.

The computing device 340 may include a global positioning system (GPS) transceiver 350 configured to receive GPS signals 352 from a global positioning satellite system, relay antenna, or the like. The memory 344 may include instructions that cause the processor 342 associate GPS data (related to the GPS signals 352) with the sonar data (related to the sonar signals 312) received from the transducer array 310.

In some examples, the computing device 340 may be configured to upload data (e.g., sonar data, sensor data, GPS data, etc.) to a network server 390 (e.g., cloud server) via the network interface 360. The network server 390 may include memory and/or at least one database on a network (e.g., cloud based network). Further, the computing device 340 may be configured to receive and associate geo-coordinate data, such as the GPS data, to sonar data and/or sensor data at any time, including prior to upload. The network may include various types of communication networks and/or cloud based networks, including wired networks and/or wireless networks.

The computing device 340 may be configured as a special purpose machine for interfacing with the trolling device 304, including the transducer array 310 and each of the transducer elements 310A, 310B, . . . , 310N. The computing device 304 may include standard elements and/or components, including the processor 342, memory 344 (e.g., non-transitory computer-readable storage medium), at least one database 380, power, peripherals, and various other computing elements and/or components that may not be specifically shown in FIG. 3. The computing device 340 may include a display device 370 (e.g., a monitor or other display) that may be used to provide a user interface (UI) 372, including a graphical user interface (GUI). The display 370 may be incorporated as part of the computing device 340 or may be a separate component. The UI 372 may be used to receive preferences and/or input controls from a user of the display device 370 for managing and/or utilizing the system 300, such as interfacing with the trolling device 304 and the transducer array 304 and controlling operation of the motor 334 via the motor controller 330. Various other elements and/or components of the system 300 that may be useful for the purpose of implementing the system 300 may be added, included, and/or interchanged, in manner as described herein.

### Computing System

Implementations of various technologies described herein may be operational with numerous general purpose or special purpose computing system environments or configurations. Examples of well-known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, tablets, wearable computers, cloud computing systems, virtual computers, marine electronics devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may be implemented in the context of marine electronics, such as devices found in marine vessels and/or navigation systems. Ship instruments and equipment may be connected to the computing systems described herein for executing one or more navigation technologies. The computing systems may be configured to operate using various radio frequency technologies and implementations, such as sonar, radar, GPS, and like technologies.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

### Marine Electronics Device

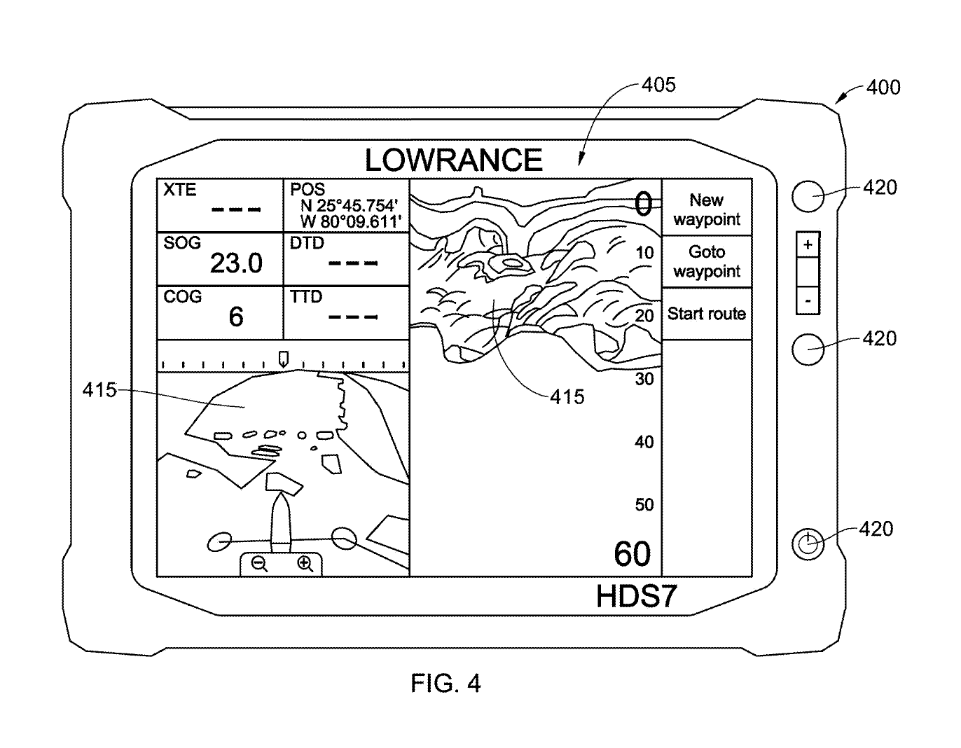

FIG. 4 illustrates an example schematic of a marine electronics device 400 in accordance with implementations of various techniques described herein. The marine electronics device 400 includes a screen 405. In certain implementations, the screen 405 may be sensitive to touching by a finger. In other implementations, the screen 405 may be sensitive to the body heat from the finger, a stylus, or responsive to a mouse. The marine electronics device 400 may be attached to a National Marine Electronics Association (NMEA) bus or network. The marine electronics device 400 may send or receive data to or from another device attached to the NMEA 2000 bus. For example, the marine electronics device 400 may transmit commands and receive data from a motor or a sensor using an NMEA 2000 bus. In one implementation, the marine electronics device 400 may be capable of steering a vessel and controlling the speed of the vessel, i.e., autopilot. For example, one or more waypoints may be input to the marine electronics device 400, and the marine electronics device 400 may steer a vessel to the one or more waypoints. The marine electronics device 400 may transmit or receive NMEA 2000 compliant messages, messages in a proprietary format that do not interfere with NMEA 2000 compliant messages or devices, or messages in any other format. In various implementations, the marine electronics device 400 may be attached to various other communication buses and/or networks configured to use various other types of protocols that may be accessed via, e.g., NMEA 2000, NMEA 0183, Ethernet, Proprietary wired protocol, etc. In some implementations, the marine electronics device 400 may communicate with other devices on the vessel via wireless communication protocols.

The marine electronics device 400 may be operational with numerous general purpose or special purpose computing system environments or configurations. The marine electronics device 400 may include any type of electrical and/or electronics device capable of processing data and information via a computing system. The marine electronics device 400 may include a marine instrument, such that the marine electronics device 400 may use the computing system to display and/or process the one or more types of marine electronics data. The marine electronics device 400 may be configured to display marine electronic data 415, such as, e.g., chart data, radar data, sonar data, steering data, dashboard data, navigation data, fishing data, engine data, and the like. Further, the marine electronics device 400 may also include one or more buttons 420 that may include either physical buttons or virtual buttons, or a combination thereof. Still further, the marine electronics device 400 may receive input through a screen 405 sensitive to touch or buttons 420.

The computing system may include a central processing unit (CPU), a system memory, a graphics processing unit (GPU), and a system bus that couples various system components including the system memory to the CPU. The computing system may include one or more CPUs, which may include a microprocessor, a microcontroller, a processor, a programmable integrated circuit, or a combination thereof. The CPU may include an off-the-shelf processor such as a Reduced Instruction Set Computer (RISC), or a Microprocessor without Interlocked Pipeline Stages (MIPS) processor, or a combination thereof. The CPU may also include a proprietary processor.

The GPU may be a microprocessor specifically designed to manipulate and implement computer graphics. The CPU may offload work to the GPU. The GPU may have its own graphics memory, and/or may have access to a portion of the system memory. As with the CPU, the GPU may include one or more processing units, and each processing unit may include one or more cores.

The CPU may provide output data to a GPU. The GPU may generate graphical user interfaces that present the output data. The GPU may also provide objects, such as menus, in the graphical user interface. A user may provide inputs by interacting with the objects. The GPU may receive the inputs from interaction with the objects and provide the inputs to the CPU. A video adapter may be provided to convert graphical data into signals for a monitor (MFD 400). The monitor (MFD 400)includes a screen 405. In certain implementations, the screen 405 may be sensitive to touching by a finger. In other implementations, the screen 405 may be sensitive to the body heat from the finger, a stylus, or responsive to a mouse.

The system bus may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory may include a read only memory (ROM) and a random access memory (RAM). A basic input/output system (BIOS), containing the basic routines that help transfer information between elements within the computing system, such as during start-up, may be stored in the ROM.

The computing system may further include a hard disk drive interface for reading from and writing to a hard disk, a memory card reader for reading from and writing to a removable memory card, and an optical disk drive for reading from and writing to a removable optical disk, such as a CD ROM or other optical media. The hard disk, the memory card reader, and the optical disk drive may be connected to the system bus by a hard disk drive interface, a memory card reader interface, and an optical drive interface, respectively. The drives and their associated computer-readable media may provide nonvolatile storage of computer-readable instructions, data structures, program modules and other data for the computing system.

Although the computing system is described herein as having a hard disk, a removable memory card and a removable optical disk, it should be appreciated by those skilled in the art that the computing system may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules, software modules, or other data. Computer-readable storage media may include non-transitory computer-readable storage media. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR), and other wireless media. The computing system may include a host adapter that connects to a storage device via a small computer system interface (SCSI) bus, Fiber Channel bus, eSATA bus, or using any other applicable computer bus interface.

The computing system can also be connected to a router to establish a wide area network (WAN) with one or more remote computers. The router may be connected to the system bus via a network interface. The remote computers can also include hard disks that store application programs. In another implementation, the computing system may also connect to the remote computers via local area network (LAN) or the WAN. When using a LAN networking environment, the computing system may be connected to the LAN through the network interface or adapter. The LAN may be implemented via a wired connection or a wireless connection. The LAN may be implemented using Wi-Fi™ technology, cellular technology, Bluetooth™ technology, satellite technology, or any other implementation known to those skilled in the art. The network interface may also utilize remote access technologies (e.g., Remote Access Service (RAS), Virtual Private Networking (VPN), Secure Socket Layer (SSL), Layer 2 Tunneling (L2T), or any other suitable protocol). In some examples, these remote access technologies may be implemented in connection with the remote computers. It will be appreciated that the network connections shown are exemplary and other means of establishing a communications link between the computer systems may be used.

A number of program modules may be stored on the hard disk, memory card, optical disk, ROM or RAM, including an operating system, one or more application programs, and program data. In certain implementations, the hard disk may store a database system. The database system could include, for example, recorded points. The application programs may include various mobile applications (“apps”) and other applications configured to perform various methods and techniques described herein. The operating system may be any suitable operating system that may control the operation of a networked personal or server computer.

A user may enter commands and information into the computing system through input devices such as buttons, which may be physical buttons, virtual buttons, or combinations thereof. Other input devices may include a microphone, a mouse, or the like (not shown). These and other input devices may be connected to the CPU through a serial port interface coupled to system bus, but may be connected by other interfaces, such as a parallel port, game port or a universal serial bus (USB).

Certain implementations may be configured to be connected to a global positioning system (GPS) receiver system and/or a marine electronics system. The GPS system and/or marine electronics system may be connected via the network interface. The GPS receiver system may be used to determine position data for the vessel on which the marine electronics device 400 is disposed. The GPS receiver system may then transmit the position data to the marine electronics device 400. In other examples, any positioning system known to those skilled in the art may be used to determine and/or provide the position data for the marine electronics device 400.

The marine electronics system may include one or more components disposed at various locations on the vessel. Such components may include one or more data modules, sensors, instrumentation, and/or any other devices known to those skilled in the art that may transmit various types of data to the marine electronics device 400 for processing and/or display. The various types of data transmitted to the marine electronics device 400 from the marine electronics system may include marine electronics data and/or other data types known to those skilled in the art. The marine electronics data received from the marine electronics system may include chart data, sonar data, structure data, radar data, navigation data, position data, heading data, automatic identification system (AIS) data, Doppler data, speed data, course data, or any other type known to those skilled in the art.

In one implementation, the marine electronics system may include a radar sensor for recording the radar data and/or the Doppler data, a compass heading sensor for recording the heading data, and a position sensor for recording the position data. In a further implementation, the marine electronics system may include a sonar transducer for recording the sonar data, an AIS transponder for recording the AIS data, a paddlewheel sensor for recording the speed data, and/or the like.

The marine electronics device 400 may receive external data via the LAN or the WAN. In one implementation, the external data may relate to information not available from the marine electronics system. The external data may be retrieved from the Internet or any other source. The external data may include atmospheric temperature, tidal data, weather, moon phase, sunrise, sunset, water levels, historic fishing data, and other fishing data.

In one implementation, the marine electronics device 400 may be a multi-function display (MFD) unit, such that the marine electronics device 400 may be capable of displaying and/or processing multiple types of marine electronics data. FIG. 4 illustrates a schematic diagram of an MFD unit in accordance with implementations of various techniques described herein. In particular, the MFD unit may include the computing system, the monitor (MFD 400), the screen 405, and the buttons such that they may be integrated into a single console.

The discussion of the present disclosure is directed to certain specific implementations. It should be understood that the discussion of the present disclosure is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of the implementations and combinations of elements of different implementations within the scope of the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort maybe complex and time consuming, but would nevertheless be a routine undertaking of design, fabrication, and manufacture for those of ordinary skill having benefit of this disclosure. Nothing in this application should be considered critical or essential to the claimed subject matter unless explicitly indicated as being “critical” or “essential.”

Reference has been made in detail to various implementations, examples of which are illustrated in the accompanying drawings and figures. In the following detailed description, numerous specific details are set forth to provide a thorough understanding of the present disclosure. However, the present disclosure may be practiced without these specific details. In other instances, well-known methods, procedures, components, circuits and networks have not been described in detail so as not to unnecessarily obscure aspects of the embodiments.

It should also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations and is not intended to limit the present disclosure. As used in the description of the present disclosure and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,”“including,”“comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A device, comprising:
a motor;
a propeller coupled to the motor;
a shaft configured to couple the motor to a watercraft; and
a housing encapsulating the motor, wherein the housing comprises a nosecone having a transducer array incorporated within the nosecone.

2. The device of claim 1, wherein the transducer array is configured for imaging an underwater environment below the surface of a body of water in which the device is deployed.

3. The device of claim 1, wherein the motor comprises an electric motor configured to drive the propeller to provide thrust for the watercraft in a body of water during operation of the electric motor.

4. The device of claim 1, wherein the housing encloses the motor within a waterproof capsule impervious to water.

5. The device of claim 1, wherein the shaft is configured to rotate relative to the watercraft to steer the watercraft in a body of water during operation of the motor.

6. The device of claim 1, wherein the shaft is configured to rotate the housing relative to the watercraft to thereby rotate the nosecone at least 360° for imaging a 360° view of an underwater environment below a surface of a body of water.

7. The device of claim 1, wherein the shaft comprises at least one electrical cable for controlling operation of the motor, wherein the operation of the motor is controlled electrically or mechanically via user input.

8. The device of claim 1, wherein the shaft comprises at least one electrical cable for controlling operation of the motor, wherein the operation of the motor is controlled by a computing device.

9. The device of claim 1, wherein the shaft comprises at least one electrical cable for transmitting sonar data signals from the transducer array to a computing device.

10. The device of claim 1, wherein the transducer array comprises a spotlight transducer array having multiple scanning transducers.

11. The device of claim 1, wherein the transducer array comprises multiple transducer elements having one or more of a right scanning transducer, a left scanning transducer, a down scanning transducer, and a conical down beam transducer.

12. The device of claim 1, wherein the housing comprises a hydrodynamic contour.

13. A trolling motor, comprising:
an electric motor having a propeller coupled thereto;
a steering shaft configured for coupling the electric motor to a watercraft; and
a housing encapsulating the electric motor, wherein the housing comprises a nosecone having a transducer array incorporated within the nosecone.

14. The trolling motor of claim 13, wherein the transducer array is configured for imaging an underwater environment below the surface of the body of water in which the trolling motor is deployed.

15. The trolling motor of claim 13, wherein the transducer array comprises a spotlight transducer array having multiple scanning transducers.

16. The trolling motor of claim 13, wherein the transducer array comprises multiple transducer elements including one or more of a right scanning transducer, left scanning transducer, a down scanning transducer, and a conical down beam transducer.

17. A system, comprising:
a trolling device configured to be coupled to a watercraft, having:
a motor having a propeller coupled thereto,
a housing enclosing the motor within a waterproof capsule, the housing having a nosecone with a transducer array incorporated therein, and
a steering shaft configured for coupling the housing to the watercraft, the steering shaft having a first electrical wire for transmitting sonar signals from the transducer array; and
a computing device electrically coupled to the trolling device via the first electrical wire, comprising:
a processor;
memory having instructions that cause the processor to:
record sonar data associated with the sonar signals received from the transducer array via the first electrical wire.

18. The system of claim 17, wherein:
the steering shaft comprises a second electrical wire electrically coupling the motor to the computing device for controlling operation of the motor, and
the instructions further cause the processor to transmit control signals to the motor via the second electrical wire for controlling operation of the motor.

19. The system of claim 17, wherein the transducer array comprises a spotlight transducer array having multiple scanning transducers.

20. The system of claim 17, wherein the transducer array comprises multiple transducer elements including one or more of a right scanning transducer, left scanning transducer, a down scanning transducer, and a conical down beam transducer.
